(19) United States
(12) Patent Application Publication
(10) Pub. No.: US 2011/0292376 A1
(43) Pub. Date: Dec. 1, 2011

(54) APPARATUS AND METHOD FOR DETECTING RAMAN AND PHOTOLUMINESCENCE SPECTRA OF A SUBSTANCE

(76) Inventors: Igor V. Kukushkin, Moscow region (RU); Leonid V. Kulik, Moscow region (RU); Aleksandr B. Van'kov, Tula (RU); Oleg A. Volkov, Moscow region (RU)

(21) Appl. No.: 12/983,175

(22) Filed: Dec. 31, 2010

Related U.S. Application Data
(60) Provisional application No. 61/348,668, filed on May 26, 2010.

(51) Int. Cl. G01N 21/00; G01J 3/30; G01J 1/58; G01J 3/44

(52) U.S. Cl. 356/73

(57) ABSTRACT

An apparatus and method for detecting Raman and photoluminescence spectra of a substance and identifying said substance by Raman and/or photoluminescence spectral characteristics of said substance are disclosed. An apparatus comprises a replaceable laser source aggregate with a laser source, a collimating system, a socket for receiving said replaceable laser source aggregate, while ensuring the operation of said apparatus with no further adjustment of a positioning of said collimating system or said laser source, a filtering system, a light dispersing system optimized for a spectral resolution and a spectral range sufficient to simultaneously obtain Raman and photoluminescence spectra of said substance, a detector, and at least one controller for processing electrical signals. The disclosed and claimed method provides for obtaining Raman and photoluminescence spectra of a substance simultaneously, for separating said spectra into components based on Raman and photoluminescence contents, for analyzing said Raman and photoluminescence contents, and for identifying said substance by utilizing a set of spectral processing methods.

### CROSS REFERENCE TO RELATED APPLICATION

This application claims the benefit of and priority to U.S. Provisional Application Ser. No. 61/348,668, filed May 26, 2010, entitled, “Raman-photoluminescence complex and Raman-photoluminescence spectral recognition system,” the contents of which are incorporated by reference herein in its entirety.

### FIELD OF THE INVENTION

The present invention relates generally to the field of photoluminescence and Raman spectroscopy, and more particularly to apparatus and methods for obtaining and analyzing spectral information of unknown substances.

### DESCRIPTION OF THE PRIOR ART

Substance analysis identification is an important subject in a number of fields of knowledge and in a number of industries. For example, substance analysis and identification are important in the fields of nutritives, pharmaceuticals and other medical products, chemistry, jewelry, and many other fields. There is a need for inexpensive, compact, sophisticated and reliable devices that are capable of performing fast, non-invasive, non-distractive and reliable analysis and identification of various substances and products.

The Raman scattering method is known for its reliability in the identification of substances. This method is based on the fact that organic and non organic molecules posses many rotational and oscillatory degrees of freedom that manifest themselves as a set of lines in the Raman spectrum. Each line is characterized by its unique spectral position and relative intensity. These spectral characteristics comprise a Raman “fingerprint” of a molecule. Such Raman “fingerprints” make it possible to detect and identify various substances. Because each chemical substance is characterized by distinguishable Raman “fingerprints,” it is also possible to analyze and identify compositions or mixtures of different substances using Raman-based methods.

A typical Raman spectroscopy setup is a complicated, cumbersome, and expensive set of laboratory equipment. It typically consists of a powerful laser, a triple grating spectrometer working in a subtractive mode, and a cooled CCD camera array. Raman spectroscopy equipment with additional microscopic resolution can be found in some modern spectroscopic laboratories. In addition to large size and substantial cost of the typical Raman spectroscopy equipment, typically, it is also characterized by insufficient sensitivity with regard to some substances. The noted high cost of modern Raman spectroscopy equipment and its large size, in combination with insufficient sensitivity of the Raman technique under some circumstances have made it difficult, if not impossible, to use such equipment for many important practical applications.

Despite important advances in relevant technological fields over the past decade, existing devices that measure Raman spectra often do not provide sufficient information to draw reliable conclusions on the nature of tested substances. For example, the existing Raman spectrometry devices are insufficient to reliably analyze colored substances, photoluminescence signal of which masks the Raman spectrum.

Raman signals often contain a detectable photoluminescence background that typically appears as a broad underlying signal. Such signal from the photoluminescence background can be caused either by one of the known constituents in the sample or, more commonly, by a highly fluorescent adventitious impurity. The extent to which this is a problem is principally determined by the relative intensities of photoluminescence and Raman signal. However, the inherently low Raman scattering probabilities of most samples mean that even what may be regarded as weak photoluminescence would provide a significant spectral weight. On the other hand, both Raman and photoluminescence signals may provide important information about tested substances. For example, in gemology, Raman and photoluminescence spectra are very useful not only for gemstone identification, but also because they can be used for the analysis of gemstone treatments. The Raman and photoluminescence capabilities can be used to identify whether diamonds have been artificially treated at high temperature and pressure to change their color and, hence, value. Treatment of emerald fissures with oil and other natural substances to enhance their clarity has been also known. Waxes and resins are used to impregnate jadeite and other porous stones. Traditionally, these treatments are detected with infrared (IR) spectroscopy, but a combination of Raman and photoluminescence spectroscopy techniques also allows detecting such treatments. Another example comes from the semiconductor industry. Photoluminescence measurements can be highly informative for semiconductor heterostructures grown by the MBE (molecular beam epitaxy) or CVD (chemical vapor deposition) techniques. Such measurements can provide information regarding the sample quality, electron density, distribution of electrons throughout a multilayer structure, type and number of impurity centers, whereas the Raman technique alone may allow to obtain only the basic information on optical phonons and to understand the composition of semiconductor heterostructures. It is therefore has been a challenging problem to create a portable spectroscopy device capable of measuring Raman and photoluminescence spectra simultaneously in a single shot with spectral range and resolution sufficient to satisfy such different applications as, for example, chemical, food, and pharmaceutical production, gemology, medicine, and semiconductor industry.

### SUMMARY OF THE INVENTION

An apparatus and methods for simultaneously detecting Raman and photoluminescence spectra in a single shot of a substance and identifying said substance by Raman and photoluminescence spectral characteristics of said substance are disclosed. The apparatus comprises a laser source aggregate (which may be replaceable) with a laser source capable of generating a laser beam; a collimating system for collimating said laser beam to said substance and for collecting scattered light from said substance, wherein said scattered light comprises Rayleigh scattering, Raman scattering, photoluminescence scattering and a reflected laser beam; a socket for receiving said replaceable laser source aggregate, while ensuring the operation of said apparatus with no further adjustment of a positioning of said collimating system or said laser source; a filtering system for filtering out said Rayleigh scattering and said reflected laser beam from said scattered light; a light dispersing system optimized for a spectral resolution and a spectral range sufficient to simultaneously obtain Raman and photoluminescence spectra of said substance; a detector for simultaneously registering a plurality of wavelengths in said Raman scattering and in said photoluminescence scattering and for generating an electrical signal as a function of said Raman scattering and said photoluminescence scattering; and at least one controller for processing of said electrical signal. A method for detecting and analyzing Raman and photoluminescence spectra of a substance comprises the steps of generating a laser beam; collimating said laser beam to said substance, thereby causing scattering of scattered light from said substance, wherein said scattered light comprises Rayleigh scattering, Raman scattering, photoluminescence scattering and a reflected laser beam; collecting said scattered light from said substance; filtering out said Rayleigh scattering and said reflected laser beam from said scattered light, thereby segregating said Raman scattering and said photoluminescence scattering; focusing said segregated Raman scattering and said photoluminescence scattering;

Dispersing said segregated Raman scattering and said photoluminescence scattering, while ensuring a spectral resolution and a spectral range sufficient to obtain simultaneously Raman and photoluminescence spectra of said scattered light; simultaneously registering said Raman and photoluminescence spectra; generating an electrical signal as a function of said Raman and photoluminescence spectra, wherein said electrical signal comprises a component based on said Raman spectrum and a component based on said photoluminescence spectrum; separating said component based on said Raman spectrum from said component based on said photoluminescence spectrum; providing a first dataset that comprises known values of Raman spectra for a first plurality of substances; providing a second dataset that comprises known values of photoluminescence spectra for a second plurality of substances; comparing said component based on said Raman spectrum with said known values in said first dataset, thereby selecting a first closest match; comparing said component based on said photoluminescence spectrum with said known values in said second dataset, thereby selecting a second closest match; and identifying said one substance based on said first closest match and on said second closest match. The instant invention further comprises spectral processing methods executable either in said at least one controller or/and in an external device such as a computer, mobile phone and the like, wherein said spectral processing methods filter Raman-photoluminescence spectrum from noise, separate said Raman and photoluminescent contents, organize access to said datasets of known values of Raman and photoluminescence spectra, search said closest matches in said datasets, retrieve said closest matches, and send said closest matches to a customer.

### DESCRIPTION OF DRAWINGS

FIG. 1 shows an optical schema of a sample embodiment of the apparatus according to the disclosed invention.

FIG. 2 shows an exploded side view of a sample embodiment of the apparatus according to the disclosed invention.

FIG. 3 shows an exploded view of an embodiment of the replaceable laser source aggregate with a socket.

FIG. 4 shows an exploded view of an embodiment of a collimating system and a filtering system.

FIG. 5 shows an exploded view of an embodiment of an attachment for positioning of a substance.

FIG. 6 shows an exploded side view of an embodiment of the apparatus according to the described invention.

FIG. 7 shows a side view of an embodiment of a fiber system.

FIG. 8 shows the Raman-photoluminescence spectrum of an unknown substance measured with an apparatus of according to the described invention with a solid state laser generating electromagnetic radiation at 532 nm. The output beam power is 10 mW, the measurement time is ten seconds. The named substance is identified as lactose by comparing with said dataset of known values of Raman spectra.

FIG. 9 shows Raman-photoluminescence spectrum of unknown gemstone measured with an apparatus according to the described invention with a solid state laser generating electromagnetic radiation at 532 nm. The output beam power is 10 mW, the measurement time is one second. The gemstone is identified as sapphire by comparing with said dataset of known values of photoluminescence spectra.

FIG. 10 shows Raman-photoluminescence spectrum of an unknown gemstone measured with an apparatus according to the described invention with a solid state laser generating electromagnetic radiation at 532 nm. The output beam power is 10 mW, the measurement time is one second. The measured spectrum has been separated in a photoluminescence content and a Raman content. The named substance is identified as emerald by comparing named contents with said datasets of known values of Raman and photoluminescence spectra.

FIG. 11 shows an example of a spectral processing architecture.

FIG. 12 shows an example of an architecture of databases of etalon Raman and photoluminescence spectra.

FIG. 13 shows Raman-photoluminescence spectra of methanol measured during a methanol purifying process with an apparatus according to the described invention with a solid state laser generating electromagnetic radiation at 532 nm.

FIG. 14 demonstrates Raman-photoluminescence spectra of trifluoroacetic and trichloroacetic acids measured with an apparatus according to the described invention with a solid state laser generating electromagnetic radiation at 532 nm. The trichloroacetic acids is a pure substance, whereas the trifluoroacetic acid contains a small amount of inorganic impurities producing the broad luminescence band.

FIG. 15 shows spectra of common diesel fuel and an intentionally purified fuel measured with an apparatus according to the described invention with a solid state laser generating electromagnetic radiation at 532 nm.

FIG. 16 shows a Raman spectrum of industrial silicon wafer measured with an apparatus according to the described invention with a solid state laser generating electromagnetic radiation at 532 nm.

FIG. 17 shows a photoluminescence spectrum of a two-dimensional electron gas in GaAs quantum heterojunction under the external magnetic field B=3T as the inset. Spectra dynamics as a function of the magnetic field is shown as an image. The spectra are measured with an apparatus according to the described invention with a diode laser generating electromagnetic radiation at 730 nm.

FIG. 18 shows a Raman spectrum of a diamond, a Raman-photoluminescence spectrum of a cubic zirconium and a Raman-photoluminescence spectrum of quarts. All spectra were measured with an apparatus according to the described invention with a solid state laser generating electromagnetic radiation at 532 nm.

FIG. 19 shows a Raman-photoluminescence spectrum of a ruby stone measured with an apparatus according to the described invention with a solid state laser generating electromagnetic radiation at 532 nm.

FIG. 20. shows Raman-photoluminescence spectra of a few common medicines measured with an apparatus according to the described invention with a solid state laser generating electromagnetic radiation at 532 nm.

FIG. 21 shows Raman-photoluminescence spectra of a the following food additives: tartaric acid, benzoic acid, and phosphoric acid measured with an apparatus according to the described invention with a solid state laser generating electromagnetic radiation at 532 nm.

FIG. 22 shows Raman-photoluminescence spectra of human urine on a SERS substrate and a Raman spectrum of pure urea for comparison, both measured with an apparatus according to the described invention with a solid state laser generating electromagnetic radiation at 532 nm.

FIG. 23 shows Raman-photoluminescence spectra of human saliva on a SERS substrate measured with an apparatus according to the described invention with a solid state laser generating electromagnetic radiation at 532 nm.

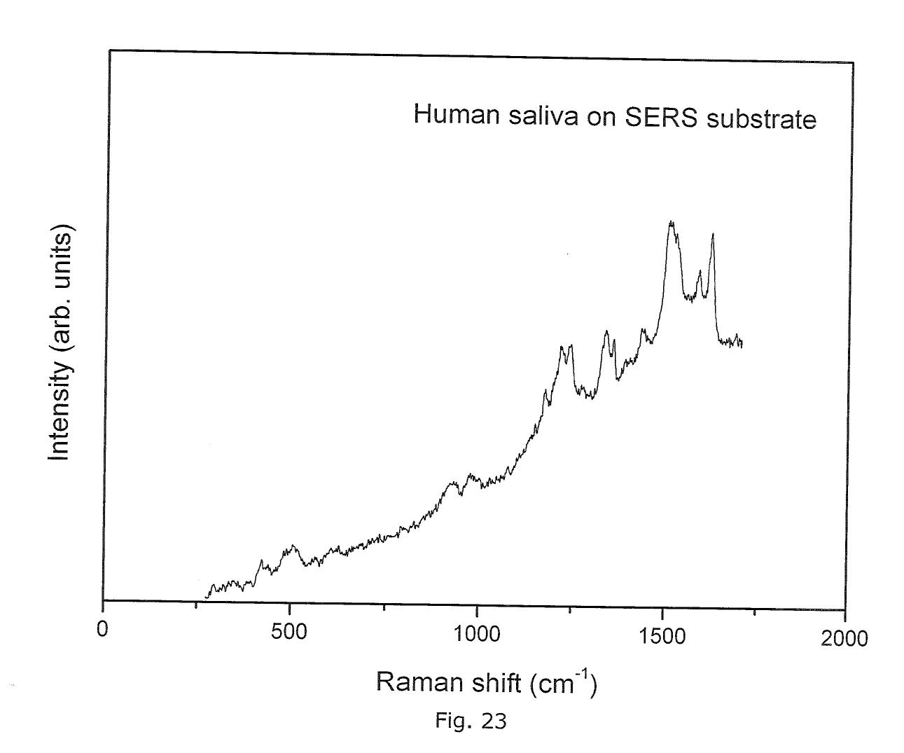

FIG. 24 shows Raman-photoluminescence spectra of a kerosene fuel marked by an organic dye (100%). It also shows mixtures of the genuine and counterfeited kerosene fuels. The spectra are measured with an apparatus according to the described invention with a solid state laser generating electromagnetic radiation at 532 nm. The percentage of the genuine kerosene (32% and 18%) is obtained from the ratio of the integral intensity of dye photoluminescence to the integral intensity of kerosene Raman scattering.

### DETAILED DESCRIPTION

The described invention is in the field of portable spectroscopic apparatus, spectral recognition systems, and client-server applications. The disclosed apparatus and methods utilize certain similarities in measuring and processing Raman and photoluminescence spectra. Raman and broadband photoluminescence signals can be measured simultaneously in a single shot with an appropriately designed spectroscopic system, whereas the difference between two spectral characteristics, i.e. Raman and photoluminescence, affects the processing stage. With a computer program based on some preliminary knowledge of spectral characteristics for a large variety of organic and non organic substances, photoluminescence and Raman signals of a measured substance can be separated into two components, each attributed either to the photoluminescence or to the Raman scattering content of the substance being measured. The photoluminescence content of the measured spectrum can be compared with known values in a dataset of photoluminescence spectra, and a closest match to the photoluminescence content can be chosen. The Raman content of the measured spectrum can be compared with known values in a dataset of Raman spectra, and a closest match to the Raman content can be chosen. Thus, utilizing the two closest matches for photoluminescence and Raman contents of the measured spectrum the named substance can be identified. The apparatus for simultaneously detecting Raman and photoluminescence spectra of a substance needs to provide the spectral resolution necessary to obtain a good quality Raman scattering signal at the room temperature, while keeping sufficiently large spectral range to record a broadband photoluminescence spectrum. These two conditions may impose limitations on the design of the apparatus.

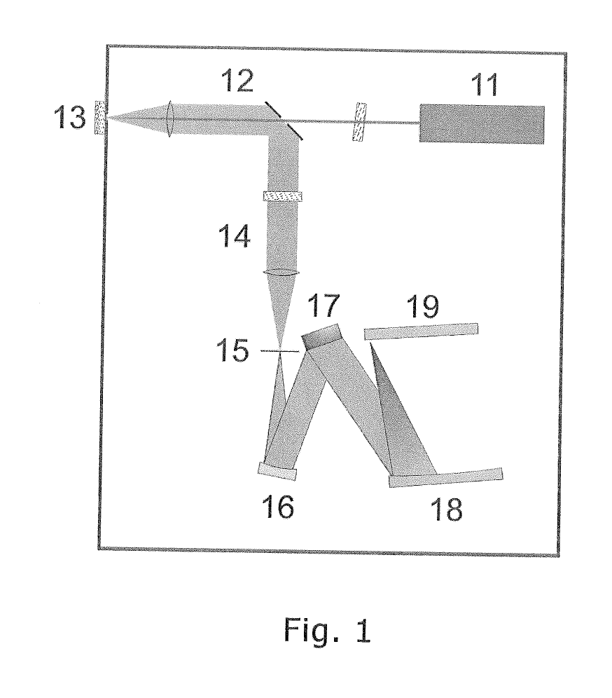

A schematic view of an embodiment of the present invention is shown in FIG. 1. The apparatus comprises a laser source capable of generating a laser beam 11, a collimating system 12, an attachment 13, a filtering system 14, a slit or a pinhole 15, a light dispersing system comprising a spherical or a parabolic mirror 16, a light dispersing element 17, a spherical or a parabolic mirror 18, a detector 19.

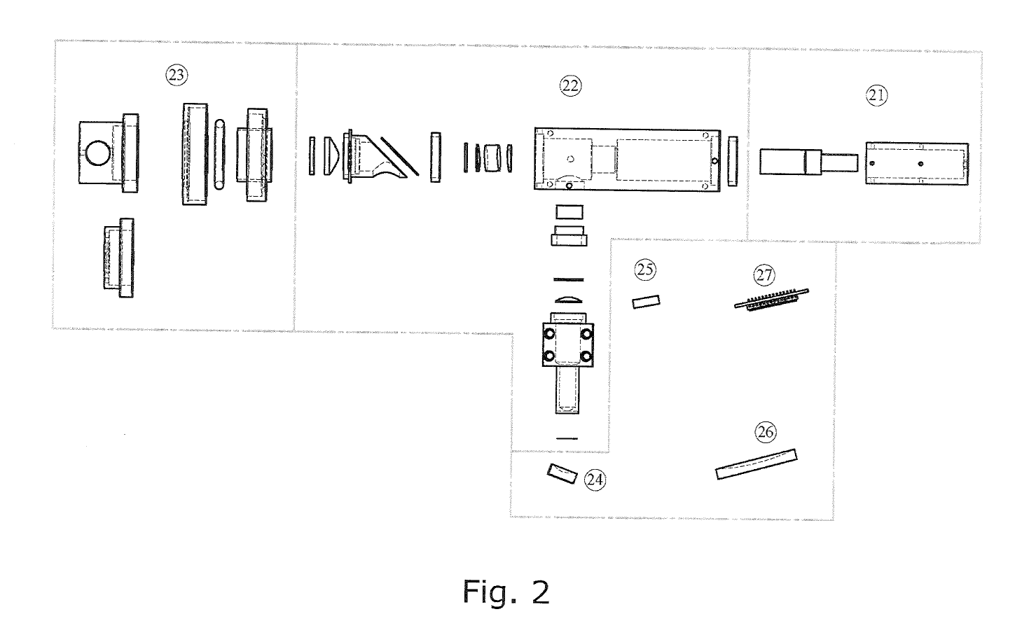

FIG. 2 shows an exploded side view one embodiment of an apparatus according to the present invention. The apparatus comprises a replaceable laser source aggregate with a laser source capable of generating a laser beam and a socket for receiving said replaceable laser source aggregate 21, a collimating system for collimating said laser beam to said substance and for collecting scattered light from said substance 22. The scattered light comprises Rayleigh scattering, Raman scattering, photoluminescence scattering and a reflected laser beam. Attachment 23 allows for positioning of the substance being examined in the focal plane of the collimating system. A light dispersing system is optimized for a spectral resolution and a spectral range sufficient to simultaneously obtain Raman and photoluminescence spectra of the subject substance and comprises a system of collimating mirrors 24 and 26 and a ruled or holographic diffraction grating 25. A multichannel detector 27 allows for simultaneous registering of wavelengths in the Raman scattering and in the photoluminescence scattering and for generating an electrical signal as a function of the Raman scattering and the photoluminescence scattering. The apparatus also comprises at least one controller for processing of the electrical signal.

In one embodiment of the apparatus pursuant to the instant invention, the laser is a diode laser. In another embodiment the laser source may comprise a solid state laser. In yet another embodiment a multichannel detector is thermoelectrically cooled and stabilized with a Peltier cooler. In yet another embodiment, the apparatus does not have a modular construction with said collimating system and said replaceable laser source aggregate separated by a non transparent cover (spectrometer housing) from said light dispersing system as it generally implies for integrated spectroscopic devices; i.e. the apparatus is constructed as a single unit on an optical bench with said collimating system 22 ending by a slit that serves as an entrance slit of said light dispersing system. This design provides for the necessary flexibility in positioning the elements of the light dispersing system for reducing the size of the apparatus as a whole and for improving spectral resolution of the apparatus. The laser beam is confined in said collimating system, whereas the light dispersing system is fully protected from the direct light exposure from the laser source.

The replaceable laser source aggregate and a socket for receiving the replaceable laser source aggregate allow to solve the known problems of long term instability caused by varying ambient conditions in the portable spectroscopic apparatus. The laser source is the most vulnerable part of the apparatus. In one embodiment, a system for quickly replacing the laser source in case of its degradation is provided. That design helps ensure that no additional adjustment of the laser beam of the laser source is necessary.

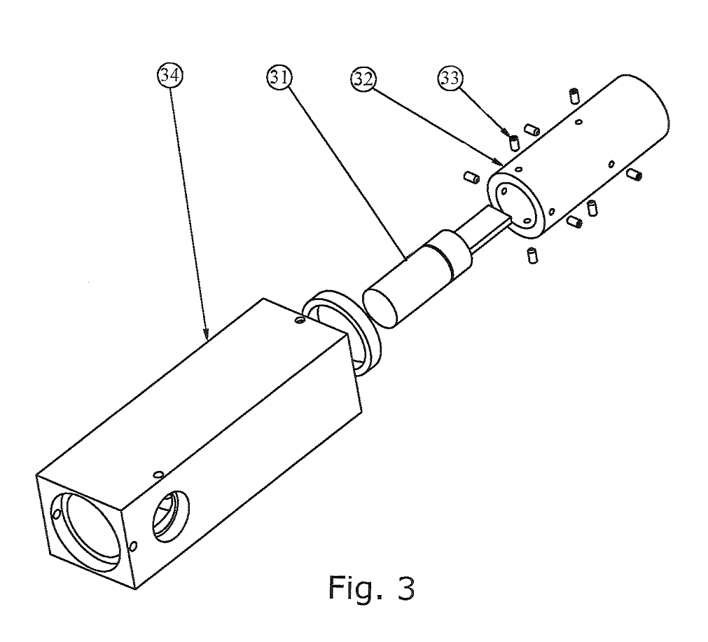

FIG. 3 shows one embodiment of the laser source aggregate and the socket for receiving the replaceable laser source aggregate. The laser source aggregate may consist of a solid state laser 31 imbedded in a holder 32. The laser beam of the laser source is aligned with high precision along the optical axis of the collimating system by adjusting the laser inside the laser holder 32 with screws 33. Laser holder 32 is inserted into socket 34 without a backslash. Therefore, no deviation of the laser beam off the optical axis of the collimating system occurs.

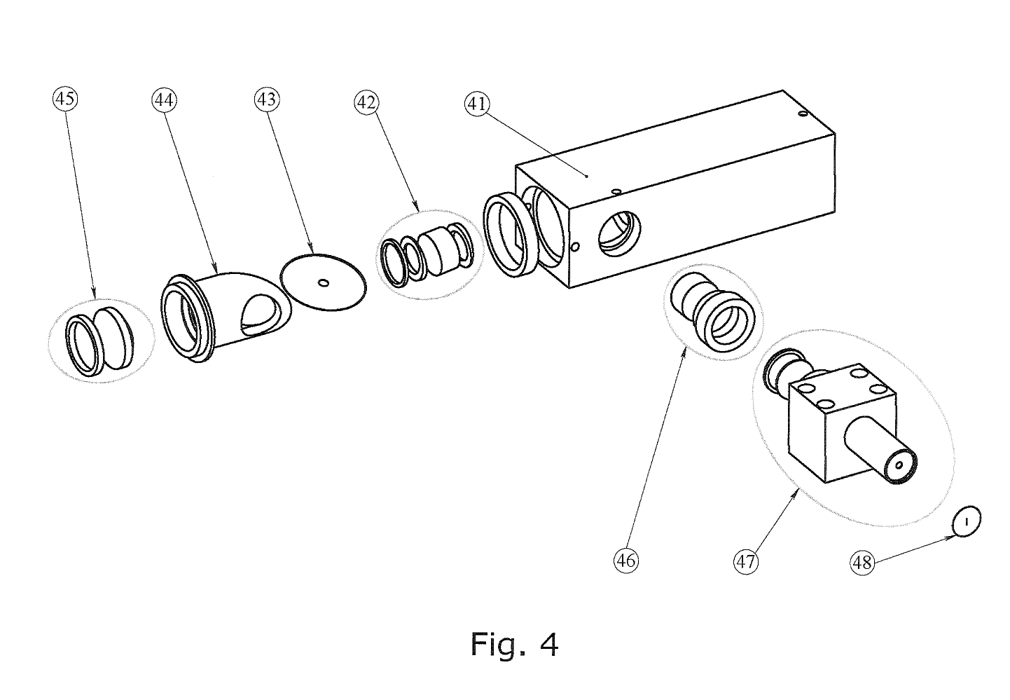

In FIG. 4, the laser beam entering socket 41 may further be directed through an interference filter 42, filtering the light of the laser source from the light at wavelengths other than the wavelengths of the laser source. In one embodiment, the interference filter is positioned at a small angle to the optical axis of the collimating system for deflecting the back-reflected laser beam off the optical axis. In another embodiment, the laser beam passes through a power attenuator, which sets a proper power output for the laser beam. In another embodiment, the laser beam is polarized with a polarizer to form either a linear polarized, or circular polarized, or elliptically polarized laser beam. The polarization selection rules are used further for analyzing the symmetry properties of the analyzed substance.

The laser beam is further transmitted through mirror 43. The mirror comprises an inner area transparent to the laser beam, wherein the inner area is sized appropriately to cause the mirror to operate as a beam splitter. Mirror 43 is positioned at an angle to the optical axis of the collimating system. The diameter of the inner area is much smaller than the outer diameter of the mirror. By choosing the diameter of the inner area larger than the diameter of the laser beam, it becomes possible to transmit the entire laser power through the inner area. At the same time, the Raman scattered and photoluminescence scattered light falls onto the entire surface of the mirror. Therefore, most of the scattered light reflects off the surface of the mirror to the light collecting sleeve 46-48 of said collimating system. This designs provides for high transmitting power of said laser beam and high transmitting power of the Raman and photoluminescence scattered light simultaneously.

The beam splitter of the design described above is preferable to the well-known design of a beam splitter based on a dichroic filter. Using a mirror as a beam splitter allows to avoid a reduction of the measurable wavelength range in close proximity to the laser beam wavelength produced by the dichroic filters always do. The light collecting sleeve comprises housing 47, low pass filter 46, collimating lens or an objective, and slit or pinhole 48.

In one embodiment, mirror 43 is attached to cylindrical mirror holder 44, whereby the minor and the mirror holder operate as a whole for adjusting the optical axis of the light collecting sleeve. The mirror and the mirror holder shift the optical axis of light collecting sleeve 47 along the optical axis of the collimating system when translated along the optical axis of the collimating system. By rotating the mirror and the mirror holder, optical axis of the light collecting sleeve can be aligned vertically. Optionally, after being properly aligned, the mirror holder can be fixed to the collimating system, for example, by glue or screws.

Mirror holder 44 terminates with a lens or objective 45, focusing the laser beam on a small area of the substance (“exposed area”) that is being analyzed. Lens or objective 45 collects scattered light from the exposed area of the substance and forms a parallel beam of the scattered light. Lens 45 has a large numerical aperture for collecting maximum possible power of the scattered light. The parallel beam is transmitted further to mirror 43. All scattered light, except for scattered light falling upon the inner area, of said mirror is reflected to filter 46. Filter 46 filters out Rayleigh scattering and reflected laser beam from the scattered light. A lens or objective installed in the housing of the light collecting sleeve 47 collimates the parallel beam and projects the parallel beam onto slit or pinhole 48.

Numerical apertures and focal lengths of lenses or objectives 45 and 47 are selected to fit the numerical aperture of collimating (spherical or a parabolic) mirror 24 (as shown in FIG. 2). The width of the slit is chosen to fit the spatial dimension of the projected image of the exposed area on the substance being examined. That ensures that no wanted Raman or photoluminescence signal collected by lens or objective 45 is lost.

A polarizer assembly for selecting a linear polarized, circular polarized, or elliptically polarized component of scattered light can be installed in the light collecting sleeve 47.

In one embodiment of the present invention, light collecting sleeve 47 and the dispersing system are set along the optical axis of the collimating system, and the laser beam propagates at an angle to the optical axis of the collimating system. In this case, no significant change in the design of the apparatus is necessary, except for a modification of the mirror. Mirror 43 in this case comprises a transparent area and a reflecting disk in the center of the mirror, the diameter of which disk is larger than the diameter of the laser beam. The disk reflects the laser beam along the optical axis of the collimating system, whereas the scattered light propagates through the transparent area of the mirror. Only a small amount of the scattered light power reflected by the reflecting disk does not expose the lens or objective of the light collecting sleeve, i.e. effectively, the mirror operates as a beam splitter.

A set of focusing attachments can be used to position the substance being examined in the focal plane of the collimating lens or objective with high precision, e.g. on the order of 1 micron.

Precise focusing is not necessary for liquid or powder substances because the penetration depths for the laser beam in such substances are typically much greater than 1 micron. The only reason to use the attachments holding of a liquid or powder substance is to keep it steady and sufficiently close to said focal plane during measurement.

However, for solid substances such as semiconductor crystals, gems, minerals, SERS (surface-enhanced Raman scattering) substrates covered with organic and inorganic substances, good quality Raman and photoluminescence signals are easier obtained if the laser beam is focused on the substances with a high degree of precision.

The design of collimating lens or objective 45 in FIG. 4 should be optimized to allow to focus the laser beam on a very small area of the substance being measured. The size of such area should be on the order of the diffraction limit of the laser light. That is why the attachments have to support translation movements along the optical axis of the collimating system with a resolution on the order of 1 micrometer.

Thus, the attachment for positioning of the substance and lens 45 should form a precise focusing system similar to that typically utilized in stationary microscopes. Yet it should be easy to use and be sufficiently compact to be employed in a portable device.

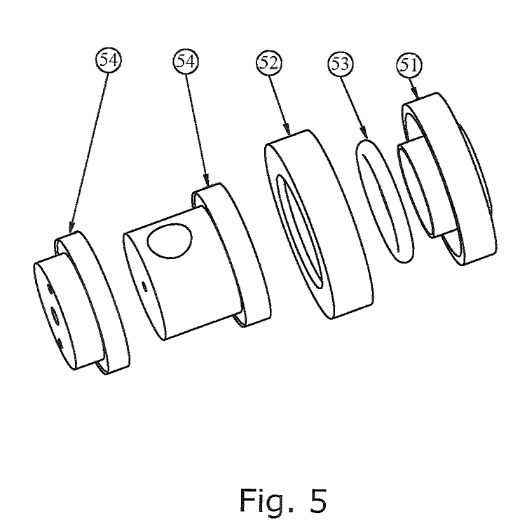

In one embodiment of the present invention, attachments for positioning of solid, liquid and powder substances are shown in FIG. 5. The attachments comprise a holder flange with thread 51, holding cover 52, which has a threaded coupling to flange 51, rubber o-ring or rigid spring 53 operating as a flexible support, and two holders 54. One holder is used for glass vials that may hold liquid or powder substances, whereas another holder positions solid substances in the focal plane of lens or objective 45. By rotating holding cover 52 around its axis, holders 54 can be moved along the optical axis of the collimating system with the necessary accuracy.

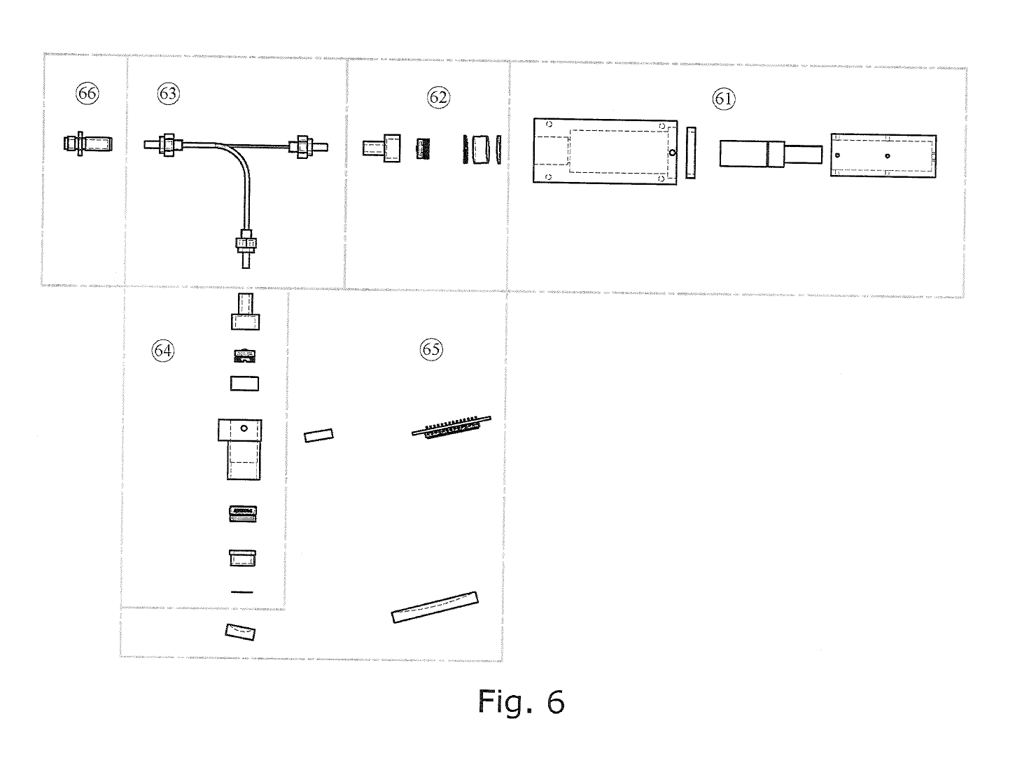

In another embodiment of the present invention, as shown in FIG. 6, the collimating system is a fiber collimating system. The fiber collimating system comprises fiber system 63, filter for filtering out said Rayleigh scattering and said reflected laser beam from said scattered light 64, fiber connector 66 and a fiber.

The apparatus with said fiber collimating system comprises a replaceable laser source aggregate with a laser source capable of generating a laser beam, an interference filter for segregating a plurality of wavelengths of said laser beam, and a socket for receiving the replaceable laser source aggregate 61. The apparatus further comprises fiber collimating system 63, 64, and 66, a light dispersing system optimized for a spectral resolution and a spectral range sufficient to simultaneously obtain Raman and photoluminescence spectra of the analyzed substance and a detector for simultaneously registering a plurality of wavelengths in the Raman scattering and in the photoluminescence scattering and for generating an electrical signal as a function of the Raman and the photoluminescence scattering 65, and at least one controller for processing of the electrical signal. In one embodiment, said fiber collimating system further comprises a power attenuator to adjust continuously or stepwise the laser power exposing the substance being measured.

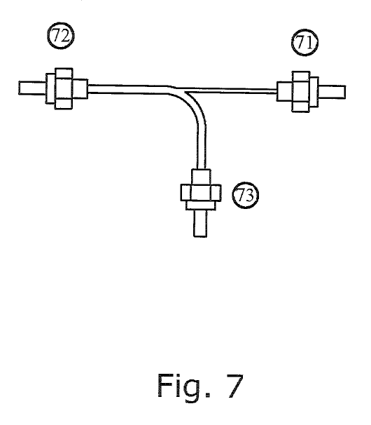

FIG. 7 shows a side view of the fiber system, as an example. The first fiber of fiber system 71 transmits the laser light from the laser source. The first fiber 71 is welded with a second fiber 72,73. The first fiber 71 has a diameter a few times smaller than the diameter of the second fiber 72,73. This way most of the laser power is transmitted directly to fiber end 72 of the fiber system.

At the same time, the scattered light power transmitted from the substance enters mostly fiber end 73. The ratio between the scattered light power transmitted to fiber end 73 and the scattered light power transmitted back to fiber end 71 equals to the ratio of squares of diameters for the fibers 72 and 71. Thus the disclosed fiber system operates as an effective beam splitter, preserving most of the wanted light power. The fiber material for the fiber system should be selected carefully to supply as little as possible Raman scattering from the fiber material itself. A sufficiently strong light scattering signal by the fiber system may mask the scattered light of the examined substance.

In one embodiment, a fiber system comprises a plurality of fibers, wherein one fiber transmits the laser beam to the examined substance, while the remaining fibers transmit the scattered light to the light dispersing system. The remaining fibers may be arranged in various geometrical forms. For example they can form a line or a circle. The remaining fibers are used to collect effectively said scattered light and to expose effectively said light dispersing system.

In one embodiment of the present invention, all optical elements of the apparatus are contained in a single housing protected tightly from the ambient light exposure. The housing should also be isolated from the surrounding atmosphere for preventing the formation of moisture condensation on the optical elements. The housing also contains electronic hardware necessary for the proper operation of the apparatus. For example, the housing may contain a controller for processing of the electrical signal. The electronic hardware may also comprise wired or wireless communication ports, such as USB, Wi-Fi, Bluetooth, Ethernet or a similar ports; power supply units; units for thermo-stabilization of the parts of the apparatus; and various controllers.

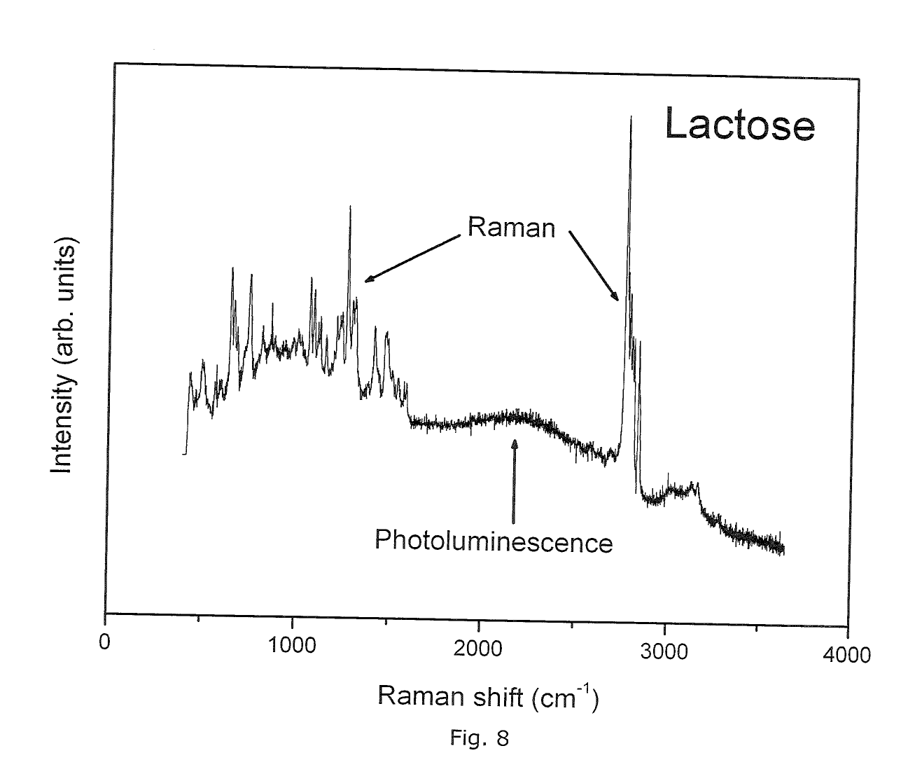

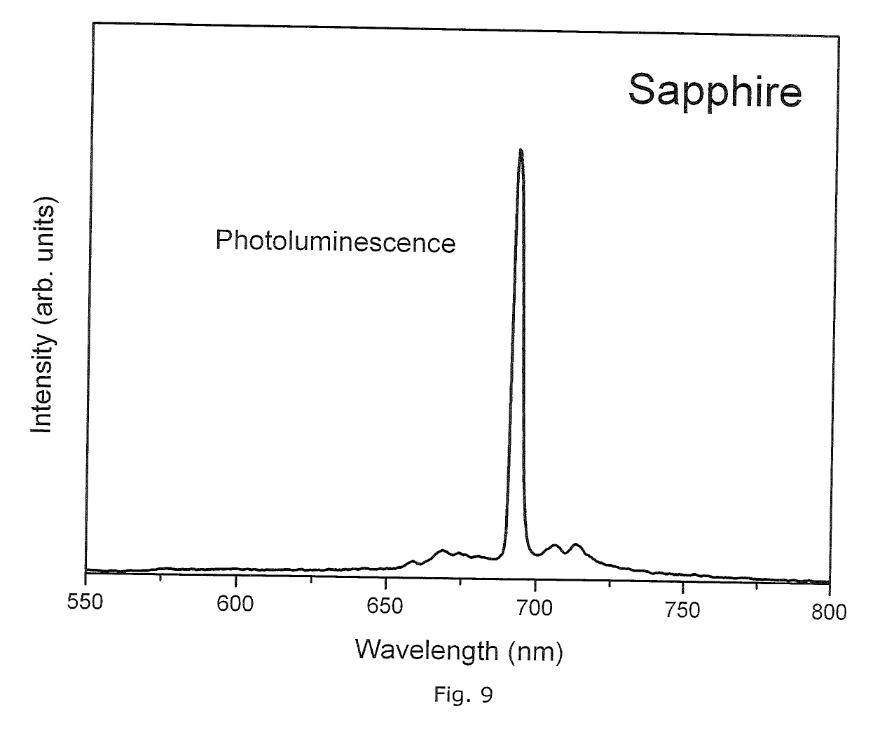

In FIG. 8 and FIG. 9, two spectra of lactose and sapphire, both measured with an apparatus utilizing a solid state laser as an excitation source generating the electromagnetic radiation at 532, are shown. The spectrum of lactose consists basically of narrow Raman lines with a weak photoluminescence background, whereas the spectrum of sapphire consists of photoluminescence lines only. These two spectra were measured with the same device in a single shot, which demonstrates opportunities for utilizing the apparatus for various applications. Lactose is a white organic substance used in pharmaceutical industry for tablet production, whereas sapphire is a colored gemstone, the Raman spectrum of which is completely masked by the photoluminescence signal.

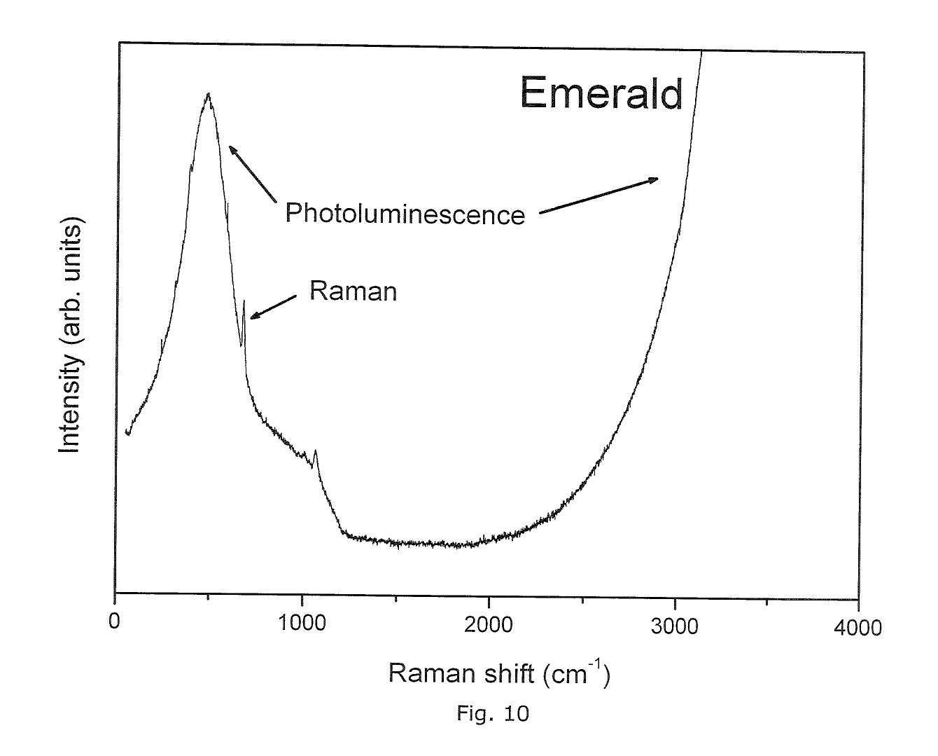

FIG. 10 shows an even more complex case of an emerald spectrum with Raman and photoluminescence lines observed with comparable intensities. The interpretation of this and similar spectra can be performed with a spectral recognition software, as discussed below.

Once the Raman-photoluminescence spectrum of an unknown substance is measured, the spectral processing procedure separates the spectrum into two components, i.e. Raman and photoluminescence, whereas the spectral recognition software identifies the unknown substance as following: it provides a first dataset that comprises known values of Raman spectra for a first plurality of substances; it provides a second dataset that comprises known values of photoluminescence spectra for a second plurality of substances; it compares the component based on the Raman spectrum with known values in the first dataset, thereby selecting a first closest match; then it compares the component based on the photoluminescence spectrum with the known values in the second dataset, thereby selecting a second closest match; finally, it identifies the substance based on the first closest match and on the second closest match.

The spectra processing algorithm consists of several layers: a firmware comprising the measurement apparatus and associated algorithms that reside in the apparatus, a system software which consists of the driver facilitating the communications between a client software and the firmware, the client software which is an application running either on the controller or on an external peripheral device such as mobile phone, smartphone, computer and the like providing all necessary controls to the end user, and, finally, a recognition server which consists of a database software with datasets Raman or photoluminescence spectra and all related algorithms. The recognition server may be either local, located on the same device as the client software, or remote, located on a dedicated server processing requests from multiple clients.

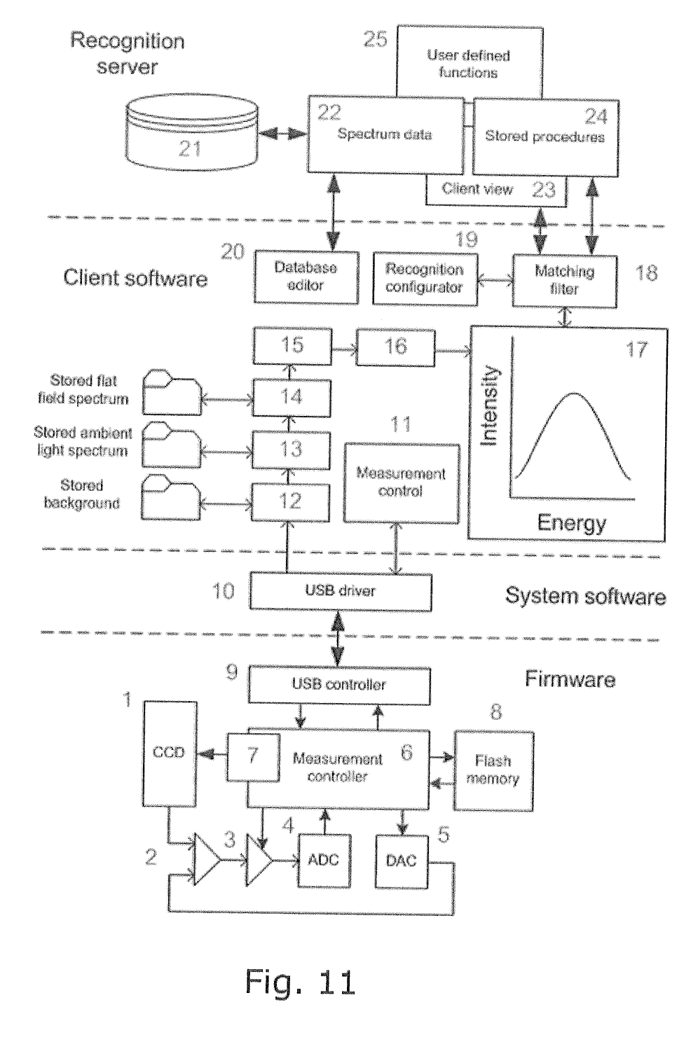

The spectra processing model, as an example, is shown in FIG. 11. The firmware processes the electric signal generated by CCD camera 1, which converts the electromagnetic radiation in the Raman-photoluminescence spectrum. An analog signal from the CCD output is processed by offset compensation circuit 2, followed by variable gain amplifier 3, and, finally, it is converted into digital form by a digital-to-analog converter 4. Measurement controller 6 is responsible for further processing of the measured signal as well as for offset voltage generating with the help of a digital-to-analog converter 5. Because the CCD sensor is read sequentially, pixel by pixel, the measurement controller has programmable clock source 7 providing the required clock signals. Data readings accumulated by the measurement controller are transmitted to the client computer via a USB interface with USB controller 9. The initial setup of the measurement controller is accomplished using the configuration data stored in flash memory 8. A part of the flash memory not used by the measurement controller keeps the unique device ID protected with a password from malicious modifications as well as a factory default configuration which may be extracted by the client software either automatically on the first start or upon the user request. The system software comprises system driver for the USB controller 9 providing serial channel abstraction over the USB link. The client software provides spectral data processing and measurement control. Measurement control module 11 is responsible for configuring measurement parameters, for starting/stopping data acquisition, and for controlling data transfer from the firmware to the client software.

During processing, the measured spectral data pass through several processing stages, each performed by a corresponding module:
Background subtraction module 12 subtracts a stored background from the measured signal. It also applies a constant dark offset compensation by taking the zero signal value from the CCD readings from light insensitive pixels.
Ambient light compensation module 13 subtracts a stored ambient light spectrum from the measured signal suppressing discrete lines coming from ambient light sources. The ambient light compensation module utilizes algorithm similar to that used for the spectrum recognition for determining intensity of the ambient light present in the measured spectrum.
Flat field normalization module 14 uses a broadband calibrated spectrum to calibrate the sensitivity of the apparatus across the working spectral range.
Spikes removal module 15 is responsible for hot pixels masking as well as for eliminating random spikes caused by cosmic rays.
Axis transformation module 16 is responsible for calibrating the spectrometer energy axis as well as for converting it into various units.

After the enumerated processing stages are performed, the measured spectrum may be presented to the end user as a graph 17 and is processed by a recognition engine. The first stage in the recognition process is matching filter 18, which reduces the noise, splits the spectrum into Raman and photoluminescence parts by their spectral bandwidth, and converts each part of the spectrum to a form facilitating fast and computationally efficient matching against the etalon spectra stored in the recognition server. The matching filter is controlled by recognition configurator 19, which searches the entire dataset of etalon spectra to find the closest matches to the measured spectrum and queries the corresponding filtering parameters. The end user may be allowed to add, remove or modify etalon spectra in the dataset by means of editor 20. The recognition server is responsible for storing reference spectra in its storage 21 and providing all related algorithms and data abstractions facilitating client requests. The latter includes the following:
Spectrum data tables 22 representing the actual data in the storage.
Client view 23 representing the part of the data directly accessible to client software.
Stored procedures 24 facilitating client requests.
User defined functions module 25 dynamically loaded into the database process implements data processing functions operating on the reference spectra which is treated as opaque binary objects by the database itself. Being implemented in the low level language, this module provides the maximum possible spectrum data processing performance.

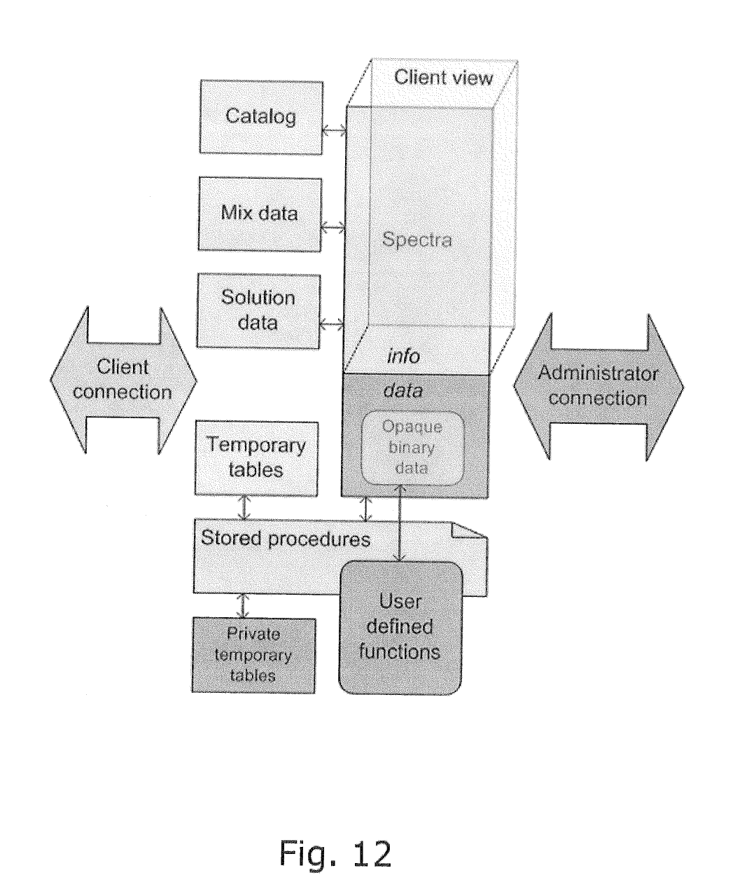

FIG. 12 shows an architecture of a database with Raman or photoluminescence spectra, as an example. The database provides a centralized storage for datasets of etalon spectra and implements most of the spectrum recognition algorithms. It also ensures proper access control for database administrators and recognition clients. Database administrators have full access to all database tables. They can add, remove or edit etalon spectra and associated data. Recognition clients have limited access to the spectrum data. They are allowed to read the spectral information and match measured spectra against etalon spectra. They have no access to the etalon spectra.

The database includes the following modules:

### Spectra Table

comprises spectral data and associated information. The associated information comprises a unique spectrum IDs, human readable names, chemical formulas, and several other descriptive fields. The spectral data comprises the spectrum itself, two kinds of the filtered spectrum ready to match and filter parameters. The spectra table is accessible only to administrators.

### Client View

provides public read only access to the spectrum information in the spectra table.

### Catalog

contains information facilitating spectrum categorization, e.g., spectrum ID and category. A client may specify one or more categories to define a subset of the database to be matched against its spectrum.

### Mix Data

is a table with mix normalization coefficients—relations between mass/volume fractions and relative intensities necessary for the mixture recognition.

### Solution Data

are data employed for recognizing solution compounds. The solution recognition is a rather challenging problem due to a mutual dependency of the spectral characteristics of diluted substances and solvents. For a proper recognition of the fractional volumes in a solution, one needs to keep a set of spectra of said solution in the database with different volume fractions of diluted substances and solvents. Besides, one should maintain an additional table to describe such exemplary solutions. The table contains the substance ID and the solvent ID as well as the volume fractions for all the spectra in the set indexed by a reference ID. The client may use this information to match a measured spectrum against a mix of solutions with different fractions to determine the exact fraction of the examined solution.

### Temporary Tables

### Private Temporary Tables

contain the mixture recognition context. Firstly, the client creates a table with a set of reference IDs for the mixture. Then the recognition context is further updated by subsequent stored procedure calls with the prebuilt data to be used for all subsequent recognition requests against this particular mixture. The temporary tables exist in the context of the particular client connection. They are visible only to the client who creates them. Private temporary tables are visible to the stored procedures only. All temporary tables are deleted automatically on the termination of a client connection.

### Stored Procedures

automate most of the spectrum recognition tasks and the proper access control.

### User Defined Functions

Because the spectrum recognition is a time consuming task, the core data processing routines are implemented in a native library dynamically loaded onto the database engine. This ensures the fast processing and reduces the data access latency. The data are stored as opaque binary strings in the spectra table so that the database itself has no way to manipulate them except for calling the user defined functions. The client encodes its spectral data locally and submits them to the database as an opaque binary string. Once the matching factor is calculated by the user-defined functions, it will be returned out of the client query as regular numeric data.

The apparatus for simultaneously detecting Raman and photoluminescence spectra of a substance opens a variety of new practical applications as it is able to collect and analyze in situ such different spectroscopic characteristics of organic and inorganic substances as Raman scattering and photoluminescence. Among such applications, for example, are scientific, industrial, medical, and various quality control applications. The apparatus according to the present invention remains functional if either Raman or photoluminescence or both overlapping spectra are present for analysis.

The method of substance identification is very convenient. There is no need for a cumbersome process of sample preparation, which, typically, is required in the vast majority of spectroscopic techniques. A liquid or powder substance is placed inside a transparent vial positioned in said attachment for liquids and powders. A solid substance is positioned in the focus plane of said collimating system using a focusing attachment for solids. The spectrum of the substance is measured immediately after turning on the laser source. The measurement process takes a few seconds for the laser output power in the range 10-100 mW. One needs about the same time to search for the closest matches through the datasets of sample Raman and photoluminescence spectra.

The apparatus can be used for in situ identification of unknown chemical substances, for monitoring chemical and petrochemical process, for controlling quality of chemical production, for fuel quality control. It is extremely useful for in situ forensic expertise, drug and explosives detection.

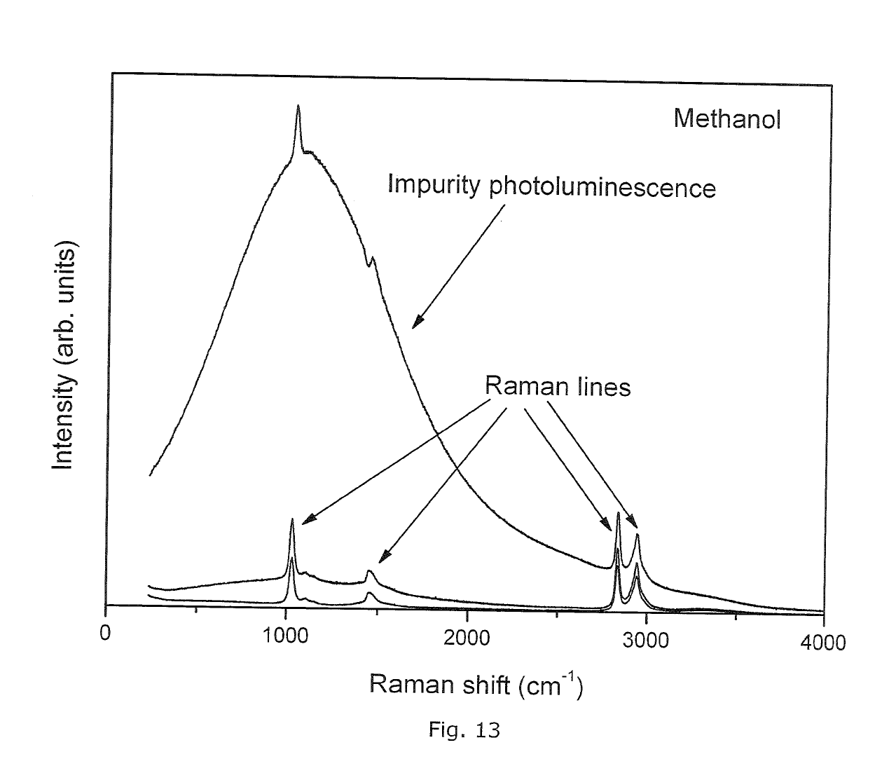

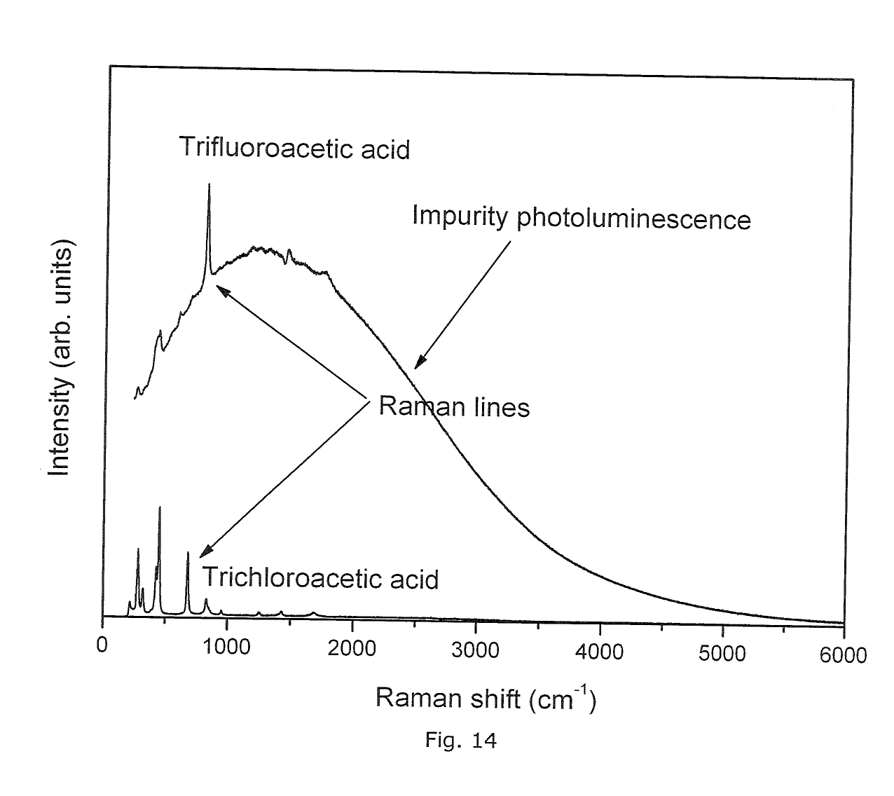

As an example, FIG. 13 shows how the spectrum of methanol changes during cleaning from inorganic impurities. The spectra are measured with an apparatus utilizing a laser source generating the electromagnetic radiation at 532 nm. In all three Raman-photoluminescence spectra of methanol, neither intensities nor spectral positions of Raman lines change, whereas the broad photoluminescence band at 1000 cm⁻¹ reduces its intensity more than an order of value while the methanol is purified. Note the methanol color does not change during the purifying process as the impurity concentration is very low for all the spectra in FIG. 13. Yet they are easily detected with said apparatus. Another example is shown in FIG. 14. It demonstrates Raman-photoluminescence spectra of trifluoroacetic and trichloroacetic acids that are widely used in organic synthesis and biochemistry. The trichloroacetic acids is a pure substance, whereas the trifluoroacetic acid contains a small amount of inorganic impurities producing the broad luminescence band.

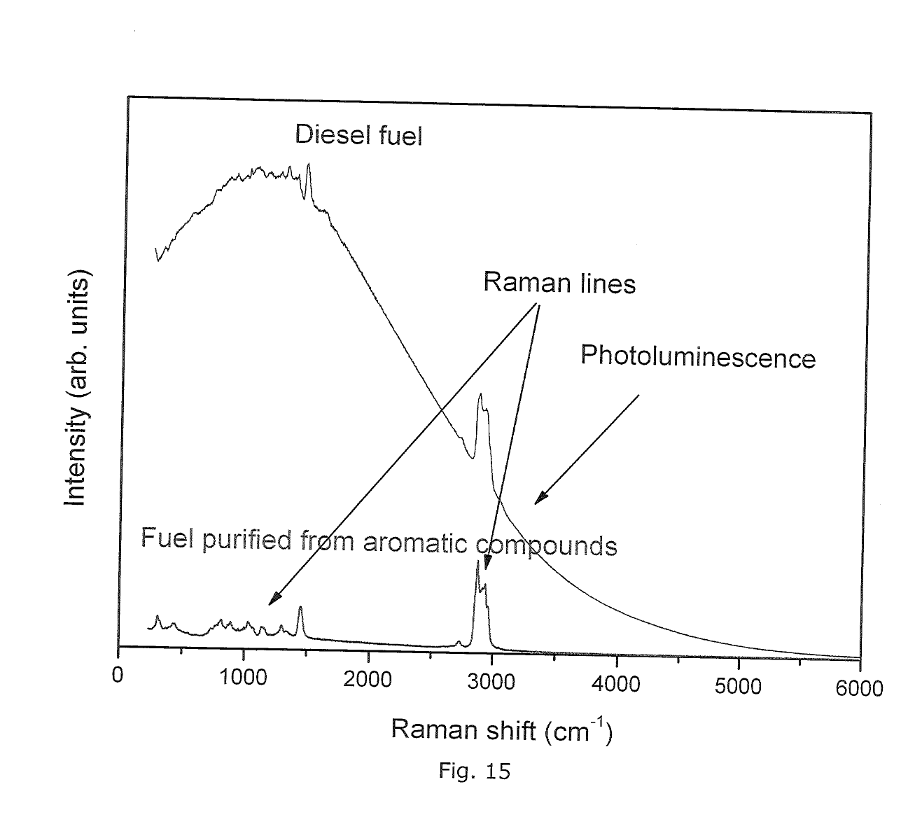

An example of fuel characterization is shown in FIG. 15. Two different fuels are measured with an apparatus utilizing a laser source generating the electromagnetic radiation at 532 nm. One fuel is purified. Its spectrum is composed basically of Raman lines. Another fuel, which is a diesel fuel, has a spectrum composed from the same Raman lines and a broad photoluminescence band emitted by impurities.

The apparatus of the instant invention may be used in the semiconductor industry for obtaining in situ photoluminescence spectra of heterojunctions, quantum wells, superlattices, quantum lasing structures, and the like. It also may be useful for in situ characterization of silicon crystallinity by monitoring the Raman band shift as silicon crystallinity changes from an amorphous to a crystalline structure, for analysis of micron-size defects and contaminations in silicon, for material science analysis of surfaces and thin films.

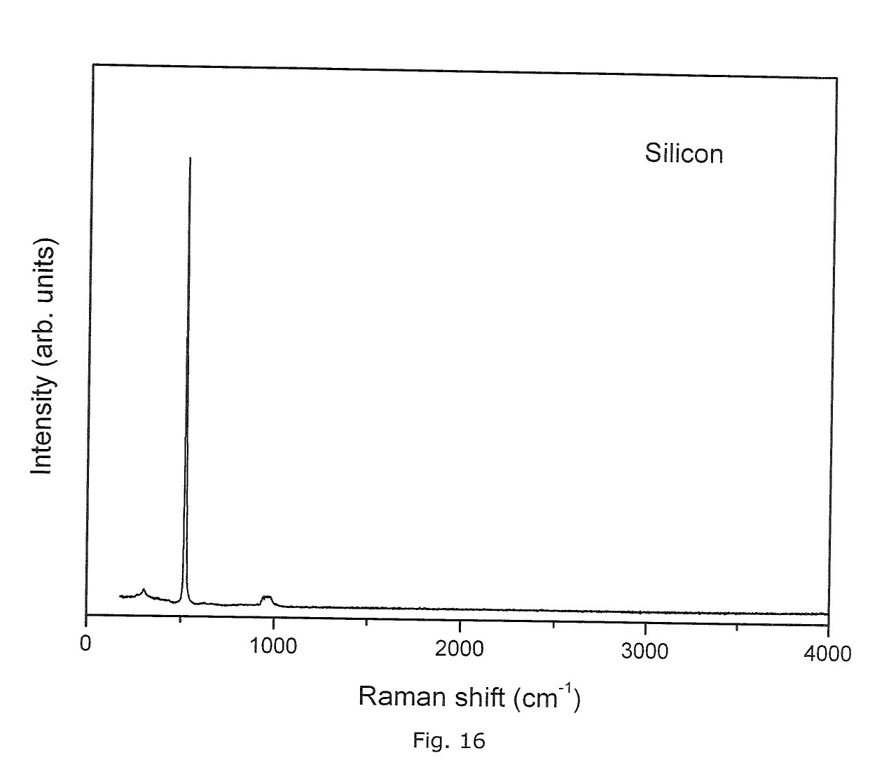

As an example, FIG. 16 shows a Raman spectrum of a silicon wafer used in semiconductor industry. The spectrum is measured with an apparatus utilizing a laser source generating the electromagnetic radiation at 532 nm. The first and second order Raman scattering lines of optical phonons in silicon are clearly seen close to 500 and 900 cm⁻¹ respectively. Normalizing the other spectral characteristics on the intensity of phonons, one can evaluate crystal properties of a wafer.

The apparatus of the present invention is also suited for routine scientific studies if an extremely high resolution is not required. In fact, it can fully substitute a complex, bulky, expensive experimental installation for taking Raman and photoluminescence spectra for scientific applications.

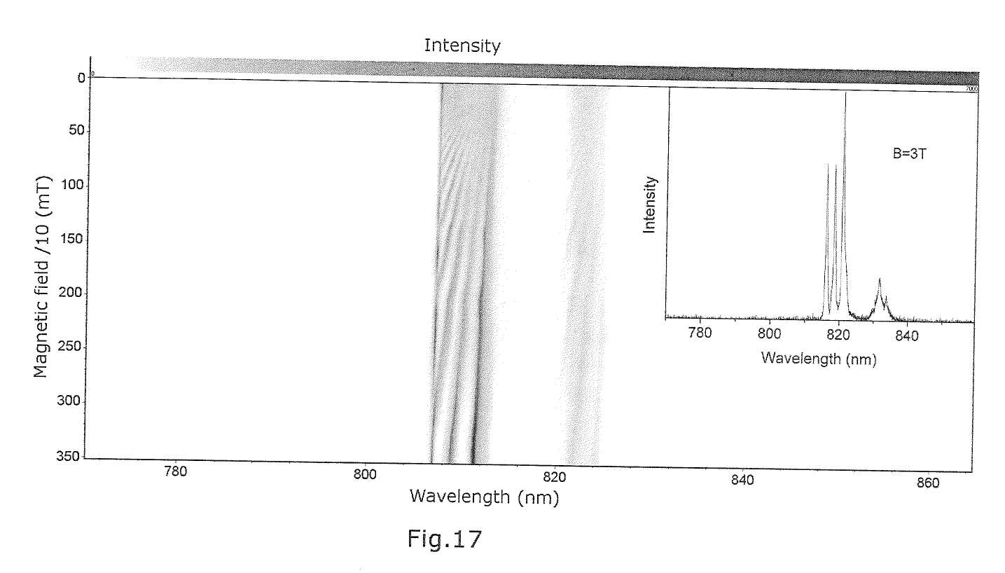

The inset in FIG. 17 shows an example of scientific photoluminescence spectrum of two-dimensional electron gas in GaAs quantum heterojunction under external magnetic field B=3T. The spectra are measured with the apparatus utilizing a semiconductor laser at 730 nm. Spectra dynamics versus magnetic field is shown as an image. The apparatus resolves Landau levels in recombination spectra of electrons with valence holes (strong lines) and with holes bound to a neutral acceptor (weak lines).

The apparatus according to the present invention can also be used as an express-analyzer in gemology for gemstone identification, gemstone forgery expertise, and analysis of gemstone origin. It can be employed in geology and mineralogy for identification of unknown minerals by their Raman and photoluminescence spectra, for examination of inclusions in minerals, and in authentication of works of art.

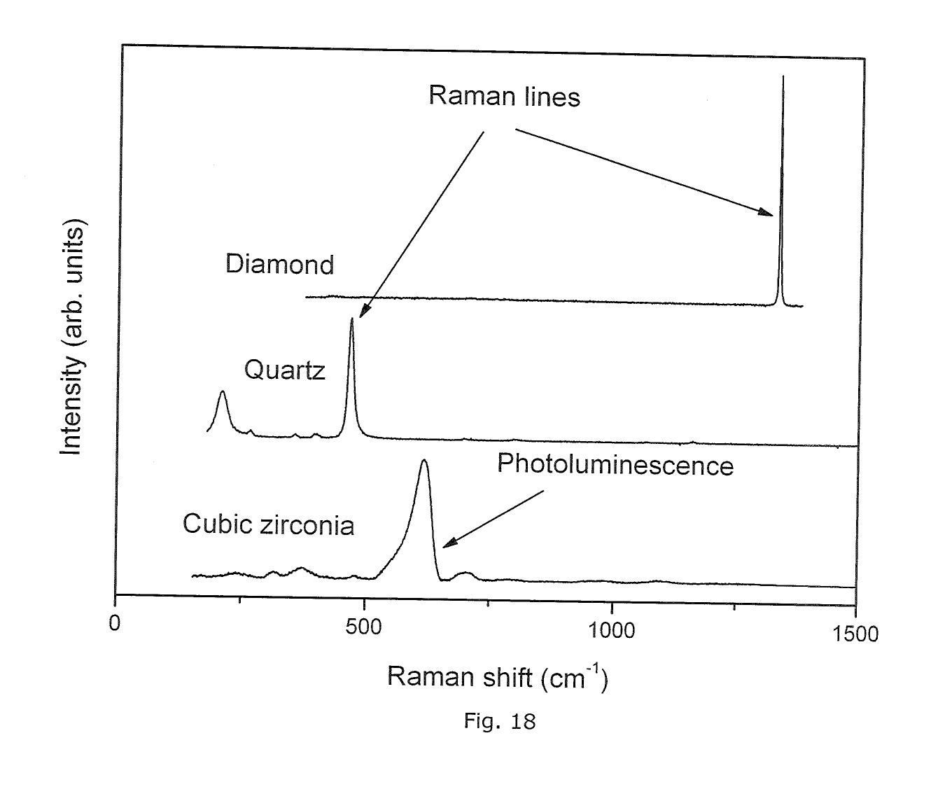

In FIG. 18, spectra of a quartz, a cubic zirconia, and a diamond are measured with an apparatus utilizing a laser source generating the electromagnetic radiation at 532 nm. A cubic zirconia or a specially treated quarts may be mistaken for a diamond. An apparatus according to the instant invention allows to easily distinguish all of such stones as Raman-photoluminescence spectra of these stones differ drastically.

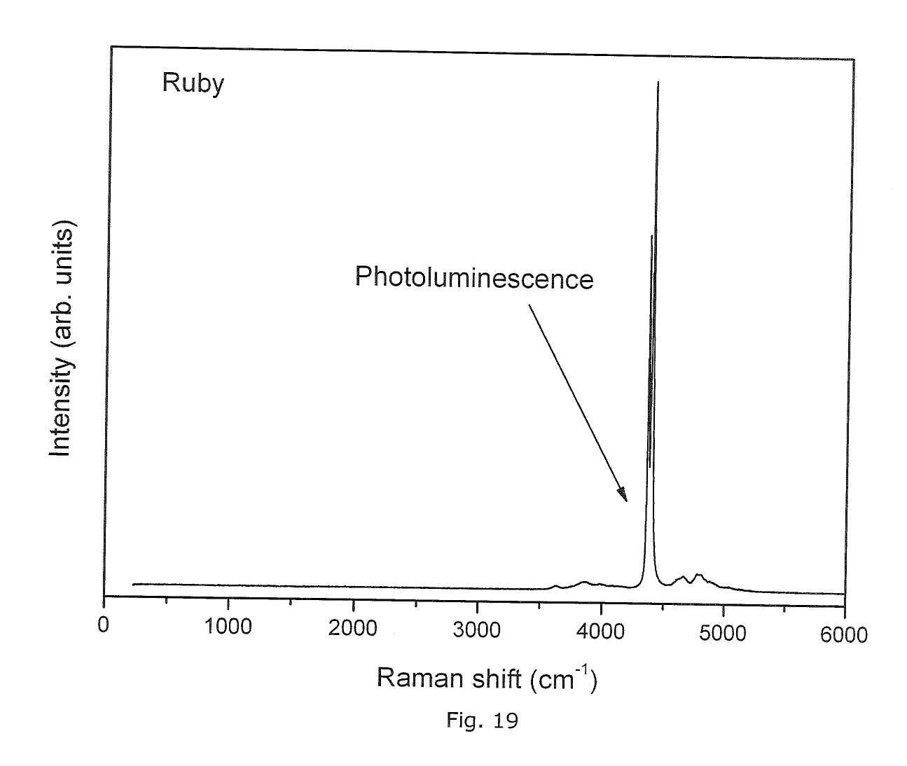

As another example, a photoluminescence spectrum of ruby is shown in FIG. 19. A ruby can be counterfeited with colored glass. The latter does not have a pronounced photoluminescence spectrum with narrow lines as ruby has. Therefore, a counterfeit can be easily identified. In addition, using an apparatus according to the present invention, one may study the relative intensities of the photoluminescence bands of a ruby and determine the origin of that ruby.

The apparatus of the present invention may also be used in pharmacology and medicine because many pharmaceutical substances as well as human body tissues emit strong photoluminescence under excitation by electromagnetic radiation in visible range, whereas some of them are transparent and active in Raman scattering.

In pharmacology, the apparatus according to the present invention can be used for quality testing and assurance of tablets, powders, and liquids, for identification of unknown substances, for detection of counterfeit pharmaceuticals, for inspection of generics, for raw material testing and verification, and for real-time monitoring of production processes.

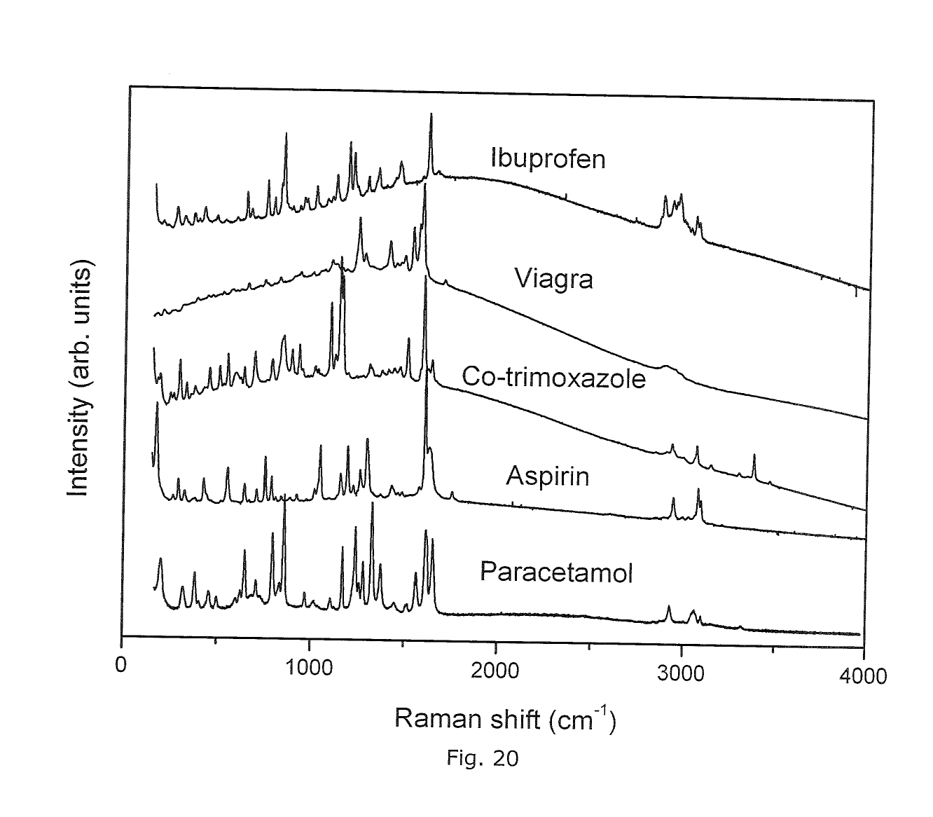

Examples of applications in medicine include analysis of human tissues, blood, skin, and cancerous tissue detection. Examples of Raman-photoluminescence scattering from a few popular pharmaceuticals measured with an apparatus utilizing a laser source generating the electromagnetic radiation at 532 nm are shown in FIG. 20.

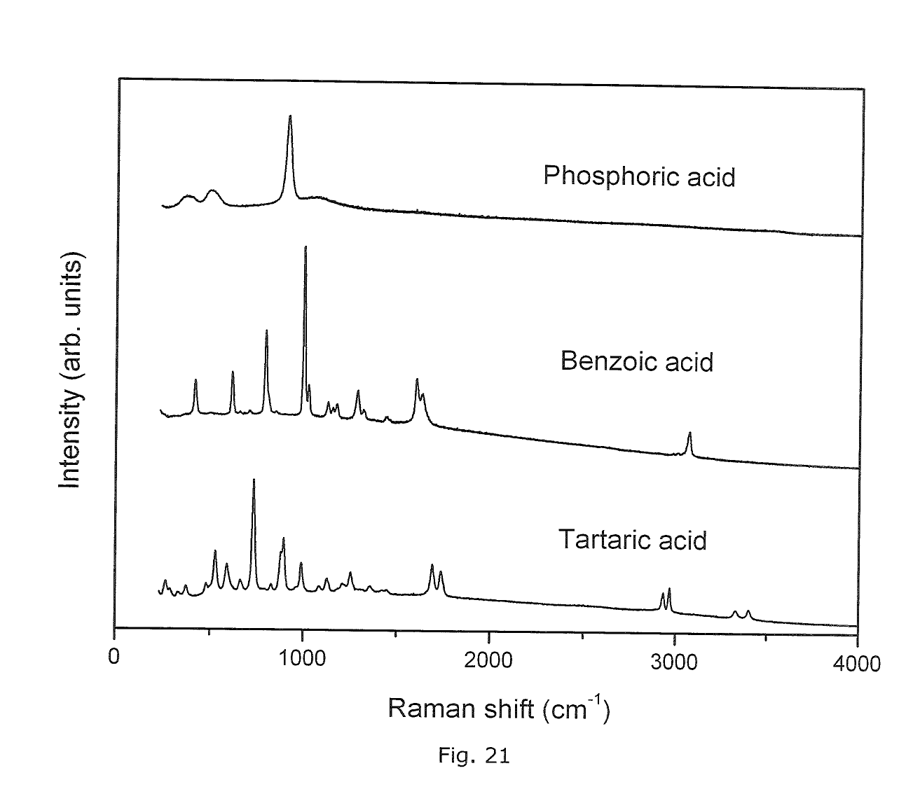

In the food industry, the apparatus of the present invention may be suitable, e.g., for quality control of transparent and colored alcoholic liquors, for identification of organic liquids commonly used as flavor and taste enhancers, stabilizers, preservatives and the like. Some examples are shown in FIG. 21, where organic and inorganic substances used in the food production industry are measured with an apparatus utilizing a laser source generating the electromagnetic radiation at 532 nm. A food additive, tartaric acid, is used as an antioxidant with E number E334; benzoic acid is used as a food preservative E210; food-grade phosphoric acid E338 is used to acidify foods and beverages.

When equipped with Surface Enhanced Raman Scattering (SERS) substrates, an apparatus according to the present invention can be used for express analysis of bodily fluids, e.g. blood, urine, sweat, saliva. FIG. 21 shows an SERS spectrum of human urine and a Raman spectrum of pure urea, for comparison, measured with an apparatus utilizing a laser source generating electromagnetic radiation at 532 nm. In the SERS spectrum of the sample of the human urine, one observes few additional Raman lines not seen in the Raman spectrum of the sample of pure urea. An analysis of the relative intensities of Raman lines provides direct information of the content of the human urine sample.

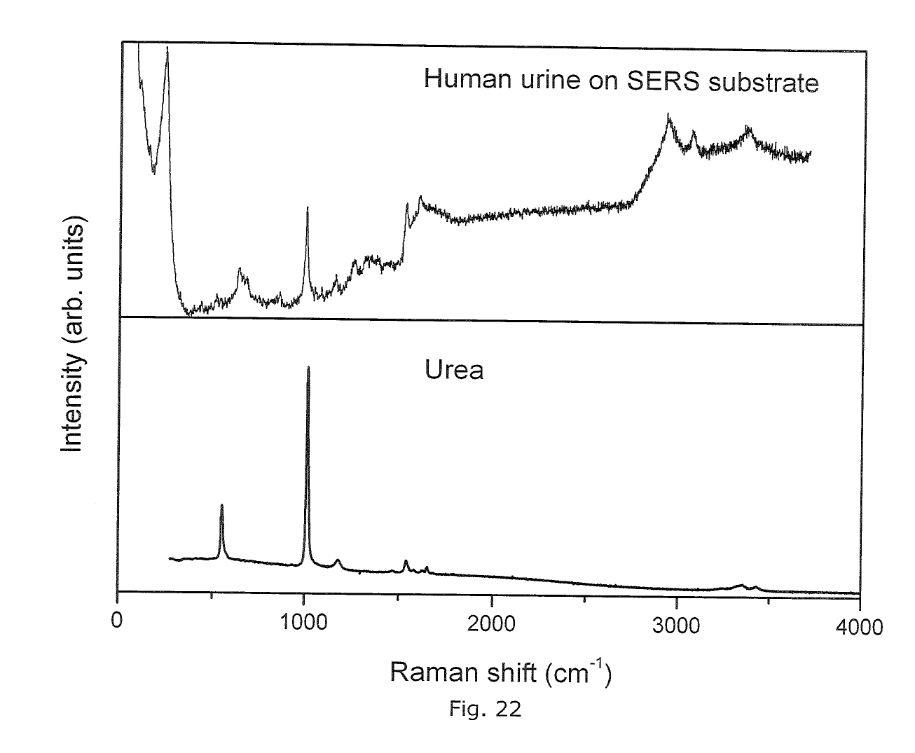

A similar analysis can be performed on the human saliva, measured with the SERS technique, see FIG. 22. SERS substrates can also be used for environmental analysis, e.g. water pollution detection, identification of hazardous contaminants in the soil, in water, air, manufactured food, and produce.

The present invention can also be used for reading printed materials containing information that has to be protected from accidental or intentional detection by specially designed inks, which emit fixed Raman or photoluminescence spectrum under external electromagnetic excitation. For example, such techniques can be used for paper watermarks, banknotes, traveler's cheques, bonds, commercial labels, barcodes, certificates, stamps, works of art, ownership documents, passports, identity cards, credit cards, brand authentication labels, and the like.

The apparatus according to the present invention may also be utilized as a metrological device for identification of genuine liquid substances: fuels, beverages, perfumes and the like marked with specially designed photoluminescent dyes. When a small amount of a photoluminescent dye or a set of dyes is diluted in a liquid substance to be protected against counterfeiting, the Raman-photoluminescence complex can check whether this liquid substance has undergone mixing with a counterfeited liquid substance of a similar molecular structure. The apparatus can determine the portion of counterfeited substance in the mixture with a high precision.

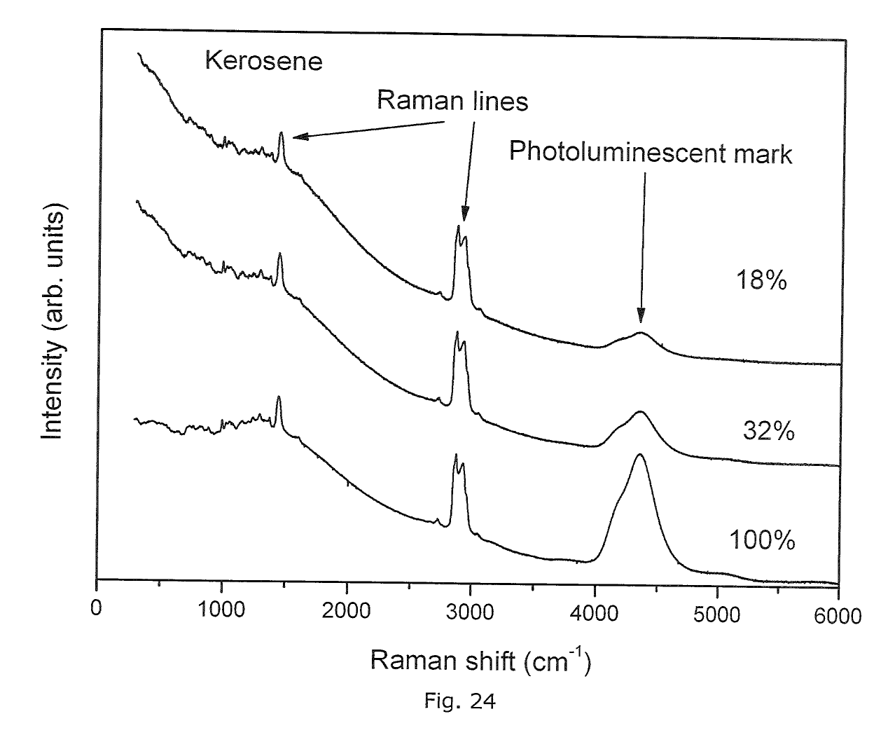

As an example, a Raman spectrum of kerosene fuel marked by an organic dye is shown in FIG. 24. The amount of dye in the kerosene is only 10⁻⁶ of the amount of kerosene itself. Yet, because of much larger photoluminescence cross-section of the dye in comparison with the Raman scattering cross-section of kerosene, the photoluminescence signal of the dye has a similar magnitude as the Raman scattering signal of kerosene. When kerosene fuel produced by an unknown manufacturer is mixed with genuine kerosene fuel marked with the photoluminescent dye, the Raman signal does not change because the total amount of kerosene in the mixture remains constant, see FIG. 24. On the contrary, the photoluminescence signal decreases as the amount of genuine kerosene in the mixture reduces. By measuring the intensity ratio of the dye photoluminescence to the Raman scattering of kerosene, one can determine the precise quantity of genuine kerosene in the mixture. The same is valid for any type of liquid substance marked with photoluminescent dyes and having detectable Raman scattering signal.

Although the present invention has been described in conjunction with its preferred embodiments, it is to be understood that modifications may be made without departing from the spirit and scope of the invention. Such modifications are considered to be within the scope of the present invention.

Below a detailed description of the spectral recognition algorithm, as an example, is enclosed which clarifies the basic concepts of filtering, matching, mixture recognition, and spectra separation in their Raman and photoluminescent contents.

### Spectrum Recognition Algorithm

The spectrum recognition problem is formulated as follows: there is a Raman spectrum f(x) and a set of Raman database spectra {vᵢ(x)}. One has to determine vᵢ(x) that is the closest match to f(x), or one has to determine a linear combination of a set of vᵢ(x) most closely matching to f(x). Therefore two recognition modes: “best match” and “mix recognition” are utilized. In the mix recognition mode, one needs to calculate mass/volume fractions of the mix components. This process will be referred to as “mix normalization”. Ultimately, it may be necessary to estimate the accuracy of the match.

### Filter Function and Matching Function

There are two key components of the matching algorithm:

### Filter Function:

[symbol] (f)→\tilde{f}

It is applied to the original spectrum in order to:
Filter out noise
Filter out slowly varying background signals
Convert original spectrum to the representation that has better “matching capability”, i.e. to the function that may be processed faster and more reliably than the original one. This function is linear. We use the first derivative of convolution with a “mexican hat” function that is a combination of two Gaussians with different width and opposite signs:

$$ℱ ( f ) = \frac{d}{d x} \int f ( x - t ) \cdot {H}_{s}^{w} ( t ) d t$$

$${H}_{s}^{w} ( t ) = {G}_{s} ( t ) - {G}_{w} ( t )$$

$${G}_{σ} ( t ) = α \int {e}^{- {t}^{2} / 2 {σ}^{2}}$$

where α is chosen so that ∫G_{c}(t) dt=1
The filter function depends from the following two parameters.
   The first slit parameter s defines the spectral resolution of the matching algorithm. It should be chosen appropriately to reduce the noise while not affecting intensity of the spectral lines.
   The second window parameter w defines the maximum width of lines to be matched. Any lines with spectral width larger than w will be smeared out.
So the filter parameters (s, w) effectively define the lower and higher boundary of the filter pass band.

### Matching Function:

\tilde{f}·\tilde{v}
It is a scalar operator on two filtered functions f(x) and v(x) characterizing similarity between its two arguments. Again, the only property of this function important for the recognition algorithm is that it must be linear with respect to both arguments. We use here, as an example, the simplest implementation, where the matching function is the function product integral:

\tilde{f}·\tilde{v}=∫\tilde{f}·\tilde{v}dx
According to the filter function implementation, we are effectively integrating the first derivative of the spectrum intensity. Therefore, the resulting weight of the spectral line will be proportional to the line peak value.

### Matching

To find the best match, one calculates \tilde{f}·\tilde{v}ᵢ for the set of reference spectra {vᵢ}. To speed up the processing, the database keeps {vᵢ,\tilde{v}ᵢ, [symbol] ᵢ} for every reference spectrum, where the filter function is represented by parameters (sᵢ,wᵢ). Parameters of the filter applied to the matching spectrum are chosen as:

(s,w)=(min(sᵢ),max(wᵢ))

Both \tilde{f} and \tilde{v} are normalized as \tilde{f}·\tilde{f}=\tilde{v}·\tilde{v}=1, and the matching result reaches unit value in case of exact matching.
The task of subtracting matched spectrum to find the residual spectrum r is more complicated. One has to find the scalar coefficient c so that:

f(x)=c·v(x)+r(x)

One may assume that

[symbol]

(r)·\tilde{v}=0,

and from the following equation

[symbol]

(f)·\tilde{v}=c· [symbol] (v)·\tilde{v}

one finds:

$$c = \frac{ℱ ( f ) \cdot \tilde{υ}}{ℱ ( υ ) \cdot \tilde{υ}}$$

### Mixture Recognition

It is possible to represent f as the weighted sum of vᵢ:

f=Σcᵢ·vᵢ+r

provided that:

[symbol]

(r)· [symbol] (vⱼ)−0∀j

This leads to the linear equation system:

$${\sum }_{i} {c}_{i} \cdot ℱ ( {υ}_{i} ) \cdot ℱ ( {υ}_{j} ) = ℱ ( f ) \cdot ℱ ( {υ}_{j} )$$

or in the matrix form:

M· c̅= b̅

where:

Mᵢⱼ= [symbol] (vⱼ)· [symbol] (vᵢ)—mixture matrix

b̅= [symbol] (f)· [symbol] (vᵢ)—mixture vector

Another important aspect of mixture recognition is normalization, which provides mass/volume fractions instead of rather abstract intensity fraction units. It involves simple normalization constant for every spectrum stored in the separate table. To provide a qualitative measure of the recognition accuracy one calculates the accuracy factor:

α=1− [symbol] (r)· [symbol] r)

where it is assumed [symbol] (f)· [symbol] (f)=⊥ so it ranges from 0 to 1 (exact match).

Having determined the mixture matrix and mixture vector, one does not need to do additional spectrum processing, and may calculate α as a fraction vector:

$$α = 1 - ( ℱ ( f ) - \sum {c}_{i} \cdot ℱ ( {υ}_{i} ) ) \cdot ( ℱ ( f ) - \sum {c}_{i} \cdot ℱ ( {υ}_{i} ) )$$

$$α = 2 \cdot {\sum }_{i} {c}_{i} \cdot ℱ ( f ) \cdot ℱ ( {υ}_{i} ) - {\sum }_{ij} {c}_{j} \cdot {M}_{ji} \cdot {c}_{i}$$

$$α = 2 \cdot {\overline{c}}^{T} \cdot \overline{b} - {\overline{c}}^{T} \cdot M \cdot \overline{c}$$

### Double Matching

If the sample spectrum includes Raman scattering lines and photoluminescence lines, the recognition is a challenging problem. Moreover some substances (e.g., minerals) may have identical Raman scattering spectrum and differ by photoluminescence lines only. Fortunately, the photoluminescence spectrum consists usually of much wider lines than Raman lines. Therefore Raman and photoluminescence lines can be separated by the filter function assuming that the filter parameters are chosen so that the photoluminescence part of the whole spectrum is filtered out. Additionally, it is possible to introduce the second filter function, complementary to the first one:

$${ℱ}^{′} ( f ) = {ℱ}_{w}^{∞} ( f ) = \frac{d}{d x} \int f ( x - t ) \cdot {G}_{w} ( t ) d t$$

$${G}_{σ} ( t ) = α \int {e}^{- {t}^{2} / 2 {σ}^{2}} ,$$

where α is chosen so that ∫G_{c}(t) dt=1
   To find the best match, the extended form of the original matching function can be used:

\tilde{f}·\tilde{v})·(\tilde{f}′·\tilde{v}′),

where

\tilde{f}′= [symbol] ′(f),\tilde{v}′= [symbol] ′(v)

This double matching function tolerates Raman and photoluminescence intensity variations much better than the original one. It is a non-linear function. Therefore it can not be used for mix recognition or for subtracting reference spectrum from the experimental one. To support double matching recognition mode, one keeps in the databases of Raman and photoluminescence spectra the pair of filtered reference functions, {\tilde{v}ᵢ,\tilde{v}ᵢ′} instead of one.

### Discrete Representation and Boundary Handling

The above discussion treated all spectra as continuous functions of their arguments. In reality, they are represented by a set of discrete points covering some limited axis range. This leads to the number of algorithm modifications:
The integrals are calculated using trapezoid rule
The convolution integral is replaced with the sum

$${\sum }_{j} {f}_{i - j} \cdot {H}_{j}$$

The Gaussian functions are calculated for some limited argument range ([−3σ,+3σ])
Because in a general case the f(x) and v(x) are defined on different sets of x axis points the latter must be interpolated at the former x axis points before using both functions in the same equation.
If spectrum's x axis extends beyond the reference spectra axis range it is clipped before matching.
Because calculating the convolution requires an argument being defined on the wider axis range than the result, it is needed to have the way to extend the spectrum definition range beyond the original boundaries. To do so, the axis mirroring technique which may be expressed as recursively applying the following transformation until the x is in the original axis range [x₀, x₁]

$$x = \{ \begin{matrix}2 {x}_{0} - x & if x < {x}_{0} \\ 2 {x}_{1} - x & if x > {x}_{1}\end{matrix}$$

What we claim is:

1. An apparatus for simultaneously detecting Raman and photoluminescence spectra of a substance, the apparatus comprising:
a laser source aggregate with a laser source capable of generating a laser beam;
a collimating system for collimating said laser beam to said substance and for collecting scattered light from said substance, wherein said scattered light comprises Rayleigh scattering, Raman scattering, photoluminescence scattering and a reflected laser beam;
a socket for receiving said laser source aggregate, while ensuring the operation of said apparatus with no further adjustment of a positioning of said collimating system or said laser source;
a filtering system for filtering out said Rayleigh scattering and said reflected laser beam from said scattered light;
a light dispersing system optimized for a spectral resolution and a spectral range sufficient to simultaneously obtain Raman and photoluminescence spectra of said substance;
a detector for simultaneously registering a plurality of wavelengths in said Raman scattering and in said photoluminescence scattering and for generating an electrical signal as a function of said Raman scattering and said photoluminescence scattering; and
at least one controller for processing of said electrical signal.

2. The apparatus of claim 1, wherein said laser source comprises a diode laser or a solid state laser.

3. The apparatus of claim 1, wherein said laser source aggregate comprises a cylindrical enclosure with said laser source, and wherein said laser beam is positioned along an optical axis of said collimating system by adjusting said laser source inside said cylindrical enclosure.

4. The apparatus of claim 1, wherein said collimating system comprises a light transmitting module, an interference filter for segregating a plurality of wavelengths of said laser beam, a mirror, a mirror holder, a light collecting sleeve, and an objective for focusing said laser beam and collecting said scattered light.

5. The apparatus of claim 4, wherein said collimating system further comprises a power attenuator.

6. The apparatus of claim 4, wherein said collimating system further comprises a polarizer for polarizing said laser beam.

7. The apparatus of claim 4, wherein said mirror comprises an area transparent to said laser beam, wherein said area is sized appropriately to cause said mirror to operate as a beam splitter;

8. The apparatus of claim 4, wherein said mirror is attached to said mirror holder, whereby said mirror and said mirror holder operate as a whole for adjusting an optical axis of said light collecting sleeve.

9. The apparatus of claim 4, wherein said light collecting sleeve comprises a housing, a low pass filter, a collimating lens, and a slit or a pinhole.

10. The apparatus of claim 4, wherein said light collecting sleeve further comprises a polarizer assembly for selecting one of linear polarized, circular polarized, or elliptically polarized components of said scattered light.

11. The apparatus of claim 1, wherein said collimating system further comprises an attachment for positioning of said substance.

12. The apparatus of claim 11, wherein said attachment comprises a surface-enhanced Raman scattering substrate.

13. The apparatus of claim 1, wherein said collimating system comprises a fiber system, a filter for filtering out said Rayleigh scattering and said reflected laser beam from said scattered light, a fiber connector and a fiber.

14. The apparatus of claim 13, wherein said fiber system comprises two connected fibers of different diameters, whereby said two connected fibers function as a beam splitter.

15. The apparatus of claim 13, wherein said fiber system comprises a plurality of fibers, wherein one fiber of said plurality of fibers transmits said laser beam to said substance and wherein remaining fibers of said plurality of fibers transmit said scattered light to said light dispersing system.

16. The apparatus of claim 1, wherein said filtering system comprises a filter for filtering out said Rayleigh scattering and said reflected laser beam from said scattered light, a slit or a pinhole, and a collimator for projecting said scattered light onto said slit or said pinhole.

17. The apparatus of claim 1, wherein said light dispersing system comprises a spherical or a parabolic mirror for forming a parallel beam, a light dispersing element, a spherical or a parabolic mirror for focusing a plurality of dispersed light beams onto said detector.

18. The apparatus of claim 1, wherein said detector comprises a charge couple device or complementary metal-oxide-semiconductor detector.

19. The apparatus of claim 1, wherein said at least one controller comprises an offset compensation circuit, a variable gain amplifier, a digital-to-analog converter, a measurement controller, and a flash memory.

20. The apparatus of claim 19, wherein said at least one controller further comprises at least one port for communication with a peripheral device.

21. A method for detecting and analyzing Raman and photoluminescence spectra of a substance, said method comprising the steps of:
generating a laser beam;
collimating said laser beam to said substance, thereby causing scattering of scattered light from said substance, wherein said scattered light comprises Rayleigh scattering, Raman scattering, photoluminescence scattering and a reflected laser beam;
collecting said scattered light from said substance;
filtering out said Rayleigh scattering and said reflected laser beam from said scattered light, thereby segregating said Raman scattering and said photoluminescence scattering;
focusing said segregated Raman scattering and said photoluminescence scattering;
dispersing said segregated Raman scattering and said photoluminescence scattering, while ensuring a spectral resolution and a spectral range sufficient to obtain simultaneously Raman and photoluminescence spectra of said scattered light;
simultaneously registering said Raman and photoluminescence spectra;
generating an electrical signal as a function of said Raman and photoluminescence spectra, wherein said electrical signal comprises a component based on said Raman spectrum and a component based on said photoluminescence spectrum; and
separating said component based on said Raman spectrum from said component based on said photoluminescence spectrum.

22. The method of claim 21, said method further comprising the steps of:
providing a first dataset that comprises known values of Raman spectra for a first plurality of substances;
providing a second dataset that comprises known values of photoluminescence spectra for a second plurality of substances;
comparing said component based on said Raman spectrum with said known values in said first dataset, thereby selecting a first closest match;
comparing said component based on said photoluminescence spectrum with said known values in said second dataset, thereby selecting a second closest match; and
identifying said one substance based on said first closest match and on said second closest match.

23. The method of claim 21, said method further comprising the steps of: providing a surface-enhanced Raman scattering substrate; and locating said substance on said surface-enhanced Raman scattering substrate.

24. The method of claim 21, wherein said one substance comprises a photoluminescent and/or a Raman dye.
